(19) United States
(12) Patent Application Publication
(10) Pub. No.: US 2009/0032506 A1
(43) Pub. Date: Feb. 5, 2009

(54) Method of Scale Manufacture

(75) Inventors: David Roberts McMurtry, Dursley (GB); Geoffrey McFarland, Wotton-under-Edge (GB); Alexander David Scott Ellin, Horsley (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge (GB)

(21) Appl. No.: 11/886,565

(22) PCT Filed: Apr. 4, 2006
(86) PCT No.: PCT/GB2006/001249

§ 371 Date: Sep. 18, 2007

(30) Foreign Application Priority Data
Apr. 13, 2005 (GB) 0507465.3

(51) Int. Cl. B23K 26/04

(52) U.S. Cl. 219/121.68; 219/121.69

(57) ABSTRACT

The present invention relates to an apparatus for the manufacture of a metrological scale comprises a scale substrate (18), at least one laser (20) for producing scale markings on the scale substrate (18), a sensor (30) to detect the depth of the scale markings produced on the scale substrate (18), and a feedback system which uses data from the sensor (30) to adjust parameters of the system to produce scale markings with the desired depth.

The present invention relates to a method of making metrological scale for scale reading apparatus. In particular, the invention relates to a method of making metrological scale using a laser.

A known form of scale reading apparatus for measuring relative displacement of two members comprises a scale on one of the members having scale marks defining a pattern and a readhead provided on the other member. An optical scale reading apparatus has means for illuminating the scale and detecting means in the readhead responsive to a resultant light pattern to produce a measure of relative displacement of the scale and readhead. A scale having its marks in a periodic pattern is known as an incremental scale and provides an output of up and down counts. A scale may be provided with reference marks, which when detected by the readhead enable the exact position of the readhead to be determined. The scale may have absolute code marks which enable the absolute position of the readhead to be determined anywhere on the scale.

Scale and readhead systems are not limited to optical systems. Magnetic, capacitance and inductive reading systems are also known.

Metrological scales may for example be linear, rotary or two-dimensional. Rotary scales may have the scale markings provided radially on a face or axially on the circumference of a rotary part.

A scale may be an amplitude scale or a phase scale. In the amplitude scale the scale pattern is made from two different types of sections. A first type of section reflects incident light to the readhead and the second type of section does not. For example an incremental amplitude scale may comprise alternate reflecting and non-reflecting lines, such as a chrome on glass scale.

A phase scale has a form that reflects light from the different sections at different phases when detected at the readhead.

International Patent Application No. WO03/661891 discloses a method of making a metrological scale in which a laser is used to produce ultra short pulses on a stainless steel ribbon which produces scale markings. A pair of readheads are provided to detect the scale markings and provide feedback which may be used to adjust the pitch of the scale.

The present invention provides apparatus for the manufacture of a metrological scale comprising:
a scale substrate;
at least one laser for producing scale markings on the scale substrate;
a sensor to detect the depth of the scale markings produced on the scale substrate; and
a feedback system which uses data from the sensor to adjust parameters of the system to produce scale markings with the desired depth.

A set of scale markings may be measured and feedback used to correct said set of scale markings. Alternatively, a first set of scale markings may be measured and feedback used to produce a second set of scale markings with the desired depth. This may be the case in a continuous process in which the second set of scale markings are downstream from the first set of scale markings.

The sensor may also detect the pitch of the scale markings and the feedback system may be used to produce scale markings of both the correct depth and the correct pitch. Either the same sensor or separate sensors may be used for depth and pitch feedback.

The parameters may comprise laser parameters such as duration of pulses or number of pulses.

The invention will now be described with reference to the accompanying drawings in which:

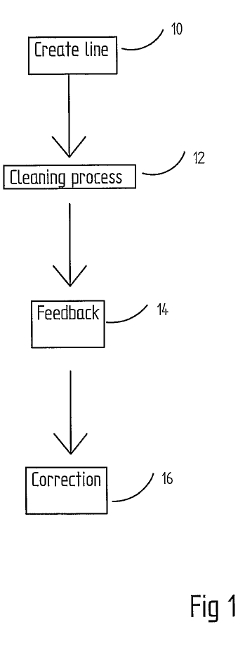

FIG. 1 illustrates a flow diagram of the present invention;

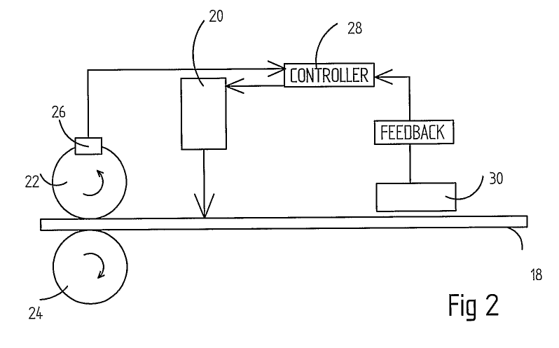

FIG. 2 is a schematic illustration of the scale marking method of the first embodiment of the invention;

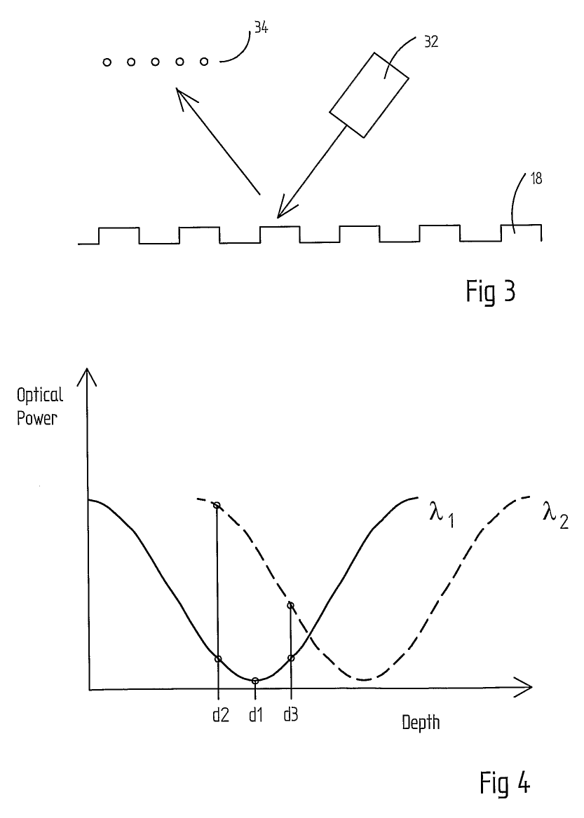

FIG. 3 illustrates the sensor used in FIG. 2;

FIG. 4 is a graph showing optical power against depth of scale marking for the sensor shown in FIG. 3;

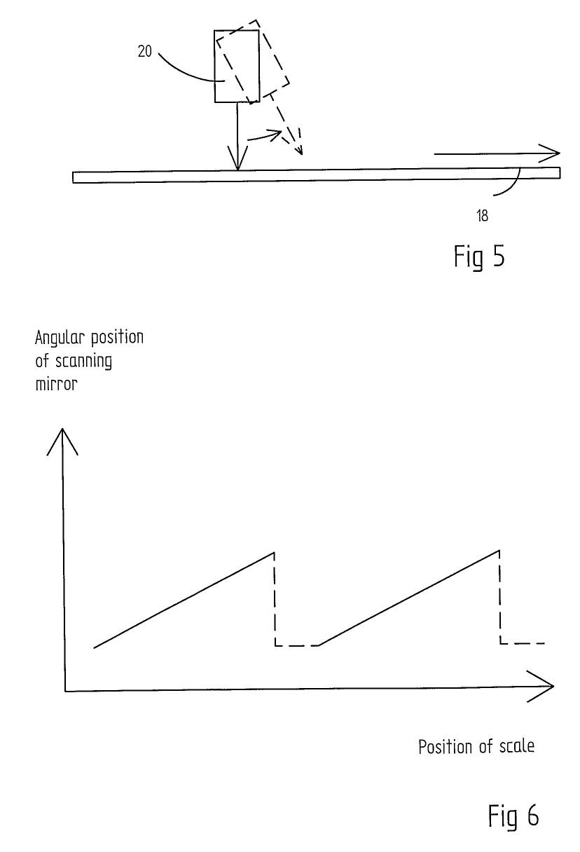

FIG. 5 is a side view of the laser of FIG. 2;

FIG. 6 is a graph showing angular position of laser against the position of scale for the system in FIG. 2;

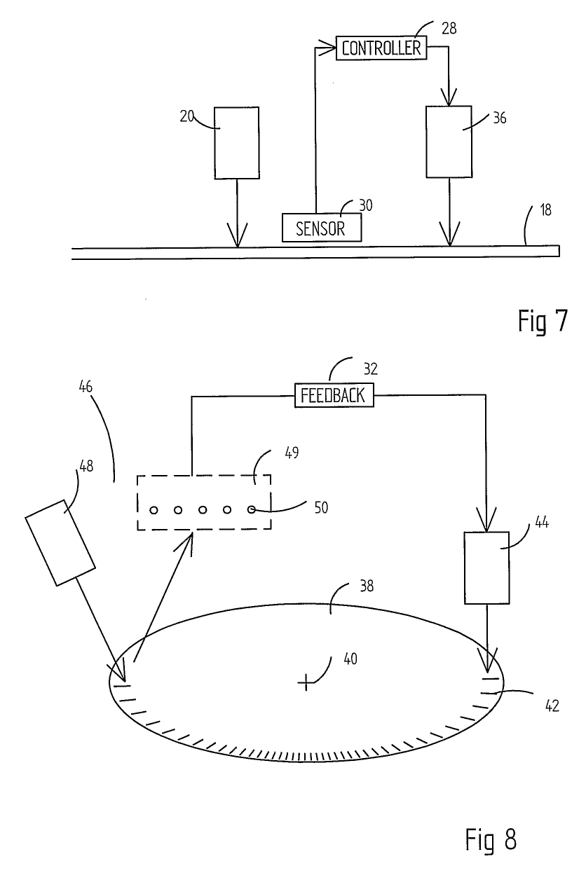

FIG. 7 is a schematic illustration of a second embodiment having two lasers;

FIG. 8 is a schematic illustration of a third embodiment for producing scale markings on a rotary scale;

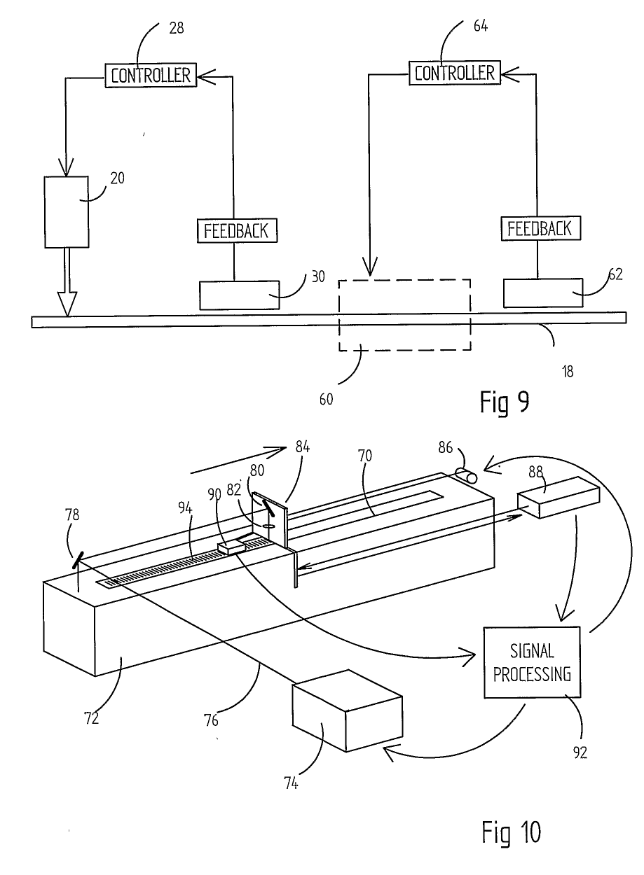

FIG. 9 is a schematic illustration of the post processing step; and

FIG. 10 is a perspective view of scale marking apparatus.

FIG. 1 is a flow diagram illustrating the main steps of the present invention. In a first step 10 scale markings are produced on the scale substrate using a laser. A pulsed laser is suitable, in which the wavelength and pulse width are chosen to suit the material of the scale substrate. The second step 12 comprises a cleaning process in which residue produced by the first step is removed from the scale substrate for example by using compressed air. This step may not be necessary, depending on the type of laser used. In a third step 14 one or more sensors are provided to sense the scale markings produced on the scale substrate. The sensors may detect the depth or both depth and pitch of the scale markings. In a fourth step 16 feedback from the sensor is used to correct the scale markings. This step may comprise using feedback from the markings already produced to adjust the parameters so that the next scale markings are produced at the correct pitch and/or depth. Alternatively this step may comprise using feedback from scale markings produced to correct those same scale markings in a subsequent step. This is suitable for correcting the depth of the scale markings.

FIG. 2 shows a manufacturing apparatus for making scale markings on a scale substrate 18 being fed past a laser 20 by a pair of rollers 22,24. The scale substrate may either be flexible (for example a ribbon) or rigid (for example a spar). It may be metallic, for example steel, or made from another material, for example glass. Pulses from the laser 20 produce scale markings on the scale substrate as it moves relative to the laser. The rollers 22,24 are provided with encoders 26 to determine the rate of movement of the scale substrate 18. This may be locked to the pulse rate of the laser 20 through a controller 28 or may be used to control the movement of the laser beam (as described with reference to FIG. 4).

Sensors 30 are provided to detect the scale markings produced by the laser 20. Feedback from the sensors is used by the controller 28 to adjust the system parameters e.g. the laser parameters.

FIG. 10 shows another set-up for the manufacturing apparatus for making scale markings on a scale substrate. The scale substrate 70 is mounted on the apparatus bed 72, this may comprise a granite bed. A laser 74 produces a laser beam 76 which is steered towards the scale substrate by a fixed mirror 78 and a movable mirror 80 and focused onto the scale substrate by a lens 82. The movable mirror 80 and lens 82 are mounted on a sliding fixture 84 which is moved along the longitudinal axis of the scale substrate by a motor 86.

The position of the sliding fixture 84 is determined using an interferometer 88. A sensor 90 is used to determine the depth and optionally the pitch of the scale markings produced by the laser beam. The sensor 90 may be mounted on the sliding fixture 84.

Outputs from the interferometer 88 and the sensor are fed to a signal processor 92. The signal processor 92 controls the motor 86 and laser parameters 74, thereby enabling adjustment of the depth and pitch of the scale markings 94.

The sensor system for detecting the pitch and depth of the scale markings is illustrated in FIG. 3. A laser 32 is used to illuminate the scale 18 and produces a diffraction pattern 34 at a detector. The separation of the diffraction orders is an indication of the pitch of the scale markings. The intensity distribution of the diffraction orders is an indication of the depth of the scale markings. Therefore the same sensor may be used to detect the depth and pitch of the scale markings. Alternatively two separate sensors may be used to detect depth and pitch of the scale markings.

Although FIG. 3 shows a reflective sensor system, a transmissive system may also be used. A glass scale substrate and e.g. an excimer laser would be suitable for a transmissive system.

FIG. 4 illustrates the variation in optical power of the zeroth order of light of wavelength λ1 as the depth of the feature is changed. If the minimum of the curve is at the chosen depth d1, then the same optical power reading will result for two different depths of scale markings d2 and d3 on either side of d1. However by illuminating the scale with light of two different wavelengths, λ1 and λ2, the correct depth of scale marking can be determined. Alternatively, a wavelength λ2 may be chosen at which the chosen depth d1 is not at a minimum, thus allowing d2 and d3 to be differentiated.

Feedback from the sensor system is sent to the controller which is used to adjust the laser output. The power and/or number of pulses of the laser output may be adjusted to adjust the depth of the scale. The rate of laser pulses can be varied to adjust the pitch of the scale.

As illustrated in FIG. 5 as the scale 18 moves relative to the laser 20, the laser beam may also be rotated e.g. by a scanner so the incident laser light continues to hit the scale substrate at the same location whilst the scale mark is being produced. When the process has finished, the laser beam will then return to its original position and the process will start again for the next mark.

FIG. 6 illustrates the movement of the laser beam relative to the scale. The length of time that the laser beam is moving so that the laser spot stays with the same position on the moving scale dictates the maximum number of pulses of the laser. The laser parameters (e.g. number of pulses) of the laser may be adjusted to any value up to this maximum to adjust the depth of the scale markings.

In FIG. 6 the solid lines indicate where the laser is on and the dashed lines indicate where the laser is off.

Alternatively as illustrated in FIG. 7, a second laser beam 36 may be provided to correct the depth of the scale markings. In this embodiment the first laser 20 produces scale markings. The sensor 30 is used to detect the depth of the scale markings produced by the laser. Feedback from the sensor 30 is sent via a controller 28 to a second laser 36 which acts on the scale markings produced by the first laser 20 so that they are at the correct depth.

This method of producing a scale is also suitable for the manufacture of other forms of scale, such as rotary scales and two-dimensional scales. This method is also suitable for short lengths of scale as well as continuous lengths of scale.

FIG. 8 illustrates the manufacture of a rotary scale. In this Figure the scale substrate is a disk 38 which is mounted in such a manner that it is rotatable about its centre 40. Scale markings 42 are produced on the outer edge of the upper surface using a burning laser 44. The disk 38 is rotated about its centre 40 as the burning laser 44 is pulsed to produce the scale markings 42. A sensor 46 is provided to detect the depth of the scale markings. As before this can comprise a laser 48 directing light incident onto the scale and a power meter 49 to detect the optical power of the diffraction orders 50. Using feedback 52 from the sensor, the disk is rotated to bring the scale markings 42 back under the burning laser 44 until the correct depth is achieved.

Other types of sensor may also be used to monitor depth of the scale markings. For example, the sensor could comprise a phase readhead, a confocal laser profiler or an atomic force microscope (AFM) probe. All of these sensors have the advantage that they can also detect the pitch of the scale markings.

This invention is suitable for both discrete lengths of scale and continuous lengths of scale. The feedback may be used to correct existing scale markings, e.g. by measuring scale markings and then using feedback to determine whether extra laser pulses are required on those scale markings. It is also suitable for continuous lengths of scale in which a set of scale marks are measured and the feedback from these markings is used to adjust system parameters to create correct future scale markings upstream.

The action of the laser on the scale substrate may produce debris on the scale substrate and thus require a post processing step to remove the debris.

A post processing step may include methods such as mechanical polishing, chemical polishing, electro polishing or ultrasonic cleaning to produce a desired finish.

A feedback loop may be provided after the post processing. FIG. 9 is a schematic diagram of the process including the post processing step. The first sensor 30 is used to detect the depth of the scale markings produced by the laser 20 as described with reference to FIG. 2. The post processing step is shown at 60. This may comprise, for example, a chemical bath, mechanical polishing or planishing. A second sensor 62 detects the depth of the scale markings and sends feedback to a controller 64. The controller 64 alters the parameters of the post processing step 60. For example, the parameters may include the concentration or temperature of the chemical bath or the pressure of the mechanical polishing/planishing.

If the step of producing the scale markings with the laser 20 produces too much debris or otherwise produces a surface that cannot be read by a sensor 30, then the sensor 62 which detects the scale markings after the post processing step 60 may be used to send feedback to the controller to alter the parameters of the laser 20.

The described invention is particularly suitable for creating scale markings on plated or solid metallic substances.

Although the above embodiments describes an incremental scale, the scale may include regions of different scale parameters forming features such as reference marks or absolute position data. For example a variation in scale pitch may be used to form these features. Alternatively the scale may include regions of different depths. Light of different wavelengths can be used to detect the different depths of scale markings.

1. Apparatus for the manufacture of a metrological scale comprising:
at least one laser for producing scale markings on a scale substrate;
a sensor to detect the depth of the scale markings produced on the scale substrate; and
a feedback system which uses data from the sensor to adjust parameters of the system to produce scale markings with the desired depth.

2. Apparatus according to claim 1 wherein a set of scale markings are measured and feedback is used to correct the said set of scale markings.

3. Apparatus according to claim 1 wherein a first set of scale marking are measured and feedback is used to produce a second set of scale markings with the desired depth.

4. Apparatus according to claim 1 wherein a sensor detects the pitch of the scale markings and the feedback system is used to produce scale markings of both the correct depth and the correct pitch.

5. Apparatus according to claim 4 wherein the same sensor is used to detect both depth and pitch of the scale markings.

6. Apparatus according to claim 1 wherein the parameters of the system comprise laser parameters.

7. Apparatus according to claim 1 wherein the sensor comprises a light source to illuminate the scale and a detector to detect a diffraction pattern produced from illumination of the scale by said light source, wherein the intensity distribution of diffraction orders is used to determine the depth of scale markings.

8. Apparatus according to claim 7 wherein the light source has a wavelength which produces a minimum of the optical power of the zeroth order at a depth which does not correspond to the desired depth of the scale markings.

9. Apparatus according to claim 7 wherein the separation of the diffraction orders is used to determine the pitch of the scale markings.

10. Apparatus according to claim 1 wherein adjustment of the power of pulses of the laser is used to adjust the depth of the scale markings.

11. Apparatus according to claim 1 wherein adjustment of the number of pulses of the laser is used to adjust the depth of scale markings.

12. Apparatus according to claim 1 wherein adjustment of the rate at which the laser is pulsed is used to adjust the pitch of the scale markings.

13. Apparatus according to claim 1 wherein the scale substrate comprises a disk and wherein the disk is rotated to bring the scale markings back under the laser until the correct depth is achieved.

14. Apparatus according to claim 1 wherein the laser is moved so that the incident laser light continues to hit the scale substrate at the same location whilst a scale marking is being produced, as the laser and scale substrate move relative to one another.

15. Apparatus according to claim 1 wherein two lasers are provided, a first laser produces scale markings on the scale substrate and the second laser corrects the depth of the scale marking.

16. Apparatus according to claim 1 wherein a post processing step is included and wherein a second sensor is provided to detect the scale markings on the scale substrate after the post processing step, and a second feedback system is provided which uses data from the second sensor to adjust parameters of the system to produce scale markings with the desired performance.

17. Apparatus according to claim 16 wherein parameters of the system comprises parameters of the post processing step.

18. Apparatus according to claim 16 wherein parameters of the system comprises parameters of the laser.

19. A method for manufacturing a metrological scale comprising:
providing a scale substrate;
at least one laser producing scale markings on the scale substrate;
a sensor detecting the depth of the scale markings produced on the scale substrate; and
a feedback system which uses data from the sensor to adjust parameters of the system to produce scale markings with the desired depth.

20. A method according to claim 19 wherein the sensor detects the pitch of the scale markings and the feedback system is used to produce scale markings of both the correct depth and the correct pitch.

21. A method according to claim 20 wherein the same sensor detects both the depth and pitch of the scale markings.

22. A method according to claim 1 in which the sensor comprises a light source and a detector, the method further comprising the light source illuminating the scale and the detector detecting a diffraction pattern produced from illumination of the scale, wherein the intensity distribution of diffraction orders is used to determine the depth of scale markings.

23. Apparatus according to claim 22 wherein the light source has a wavelength which produces a minimum of the optical power of the zeroth order at a depth which does not correspond to the desired depth of the scale markings.

24. Apparatus according to claim 22 wherein the separation of the diffraction orders is used to determine the pitch of the scale markings.
